(19) United States
(12) Patent Application Publication
(10) Pub. No.: US 2024/0410532 A1
(43) Pub. Date: Dec. 12, 2024

(54) Anti-Explosive Natural Gas Compressor with Selective Dosing

(71) Applicant: DELTA COMPRESION S.R.L., Buenos Aries (AR)

(72) Inventors: Martín Emilio Rafael Guma, Buenos Aries (AR); Gustavo Alejandro Grosso, Buenos Aries (AR)

(73) Assignee: DELTA COMPRESION S.R.L., Buenos Aries (AR)

(21) Appl. No.: 18/443,298

(22) Filed: Feb. 16, 2024

(30) Foreign Application Priority Data
Jun. 9, 2023 (AR) P20230101484

(51) Int. Cl. F17C 13/12; F17C 13/02

(52) U.S. Cl. CPC F17C 13/12; F17C 13/025; F17C 2221/033; F17C 2227/0157; F17C 2250/032; F17C 2250/043; F17C 2260/042; F17C 2265/063

(57) ABSTRACT

The present invention refers to a new natural gas compressor with variable dosing and anti-explosion protection, specially designed to improve efficiency of compressors located in remote zones where a gas pipeline is out of reach, whose supply pressure decreases as the trailer (4) pressure is reduced. The upgrade comprises an inlet pressure sensor (5) that will define the number of compression stages. In the case of high inlet pressure (approximately 250 to 50 bar) two compression stages will be performed, so that the gas will enter directly into the compressor of the second stage (B), and if the pressure is low, the gas will be compressed in three stages until the pressure to supply the vehicles is achieved. To secure the surrounding area, the compressor is designed within an anti-explosion enclosure and it is provided with safety measures such as storage venting and fire extinguishers.

### CROSS-REFERENCE TO RELATED APPLICATIONS

This application claims priority to Argentine Pat. App. No. P20230101484, filed Jun. 9, 2023, the disclosures of which are incorporated by reference herein in their entirety.

### FIELD OF THE INVENTION

The registration of a patent of Invention requested for the present invention refers to an ANTI-EXPLOSIVE NATURAL GAS COMPRESSOR WITH SELECTIVE DOSING, specially designed to improve the compression efficacy of natural gas from a mobile transport unit to supply a compressed natural gas (CNG) refueling station, with the final purpose of refueling vehicles of any type.

More specifically, the present invention refers to the general technical field of natural gas compressors, especially adapted to increase efficiency of the remotely located refueling stations, where the supply from natural gas pipelines is out of reach. Said remote locations must rely on tankers that are specific for natural gas transportation.

The present invention defines a new combination of means designed to achieve a greater result, said invention being unpredictable and surprising, even for those skilled in the art. Consequently, in addition to being novel, its constructive and functional conception shows a clear inventive activity, so that it meets the conditions required by Law to be considered as a patent of Invention.

### BACKGROUND

The use of compressed natural gas (CNG) as a fuel for vehicles, cars, industries, etc., has been known for many years and it is used in many areas of the world. In large cities, there are gas pipelines that feed the refueling stations and every station has a compressor to elevate the gas pressure from the line pressure (1 bar) to the service pressure (200 bar). For remote locations, the conventional way to handle natural gas is by trucks transporting the gas from the pipeline to the refueling station.

Within the prior art in the matter, diverse remote gas dosing systems to supply refueling stations are well known.

Specifically, patent CA2546985C discloses a compression system with multiple input streams comprising a first compressor having a first stage and a second stage, where the first stage compresses a first gas and the second stage compresses a combination of a fourth gas and an intermediate compressed gas from the first stage; and a second compressor having a first stage and a second stage, where the first stage compresses a second gas and the second stage compresses a combination of a third gas and an intermediate compressed gas form the first stage; and pipeline means to combine the discharge of the second stage from the first compressor, and the discharge of the second stage from the second compressor, to provide a compressed gas. The second gas is at a higher pressure than the first gas, the third gas is at a higher pressure than the second gas, and the fourth gas is at a higher pressure than the third gas. The system has a particular application for multi-stage refrigeration, especially for LNG (Liquefied Natural Gas). Although the aim is to improve energy efficiency for its compression, the conceived solution is different from the one that is being proposed.

On the other hand, patent BR020104381 discloses a device for storing, transporting and supplying compressed natural gas comprising a gas storage and transport module as well as said module loading, transporting and unloading means. The aforementioned module comprises cylinders, where the gas is stored, a frame, containing the cylinders, and an interconnection pipe used to disconnect and connect said module from its place of location and use, while such module loading, transporting and unloading means comprise a loading platform, an unloading platform, and a trailer. In spite of being a remote supply complete system, a variable dosing method of the gas to be compressed is not proposed.

Patent AR050409A 1 discloses a transportable compressed natural gas supplying equipment made up of storage modules, loading and unloading platforms, transport and sequence of use. This equipment constitutes an integral solution for supplying compressed natural gas (CNG) to remote locations where regular gas supply is not accessible, the equipment is composed of storage modules, loading and unloading platforms, and module transport and a sequence of its use. The modules consist of a protective cage with fiberglass lids and they contain a pack of compressed gas cylinders inside. Pipes interconnect these cylinders with each other; there are also shut-off valves, relief valves, excess valves and pressure gauges. In addition, rubber dividers separate these cylinders from each other. The equipment consists of module loading and unloading platforms with a sequence of use for modules switching. Although a solution for remote stations is proposed, it comes down to a gas storage system not including any dosing selective system towards the compressor.

Patent US1035903282 reveals a natural gas compressor and related devices, systems and methods. This natural gas compressor may include a pre-preparation chamber coupled to a supply line to receive natural gas from the supply line. The compressor may additionally include a first stage chamber coupled to a supply line to receive natural gas from the supply line. The first stage chamber may be also coupled to the pre-preparation chamber to receive natural gas from the pre-preparation chamber that has been compressed by the pre-preparation chamber. The compressor may also include a second stage chamber configured to receive natural gas that has been compressed by the first stage chamber. While two compression stages are proposed, a pressure method indicating the number of compression stages that will be required is not demonstrated.

The US20180094772A1 specification refers to a virtual gaseous fuel pipeline proposing an end-to-end solution for gaseous fuel transporting without using physical pipelines. A virtual pipeline system and its methods may involve transportation of gaseous fuels including compressed natural gas (CNG), liquefied natural gas (LNG) and/or absorbed natural gas (ANG). An exemplary pipeline system may include a gas supply station, a mother station to treat gaseous fuels from the gas supply station, a mobile transportation system to receive and transport gaseous fuels and a user site to unload gaseous fuels from the mobile transportation system. The unloaded gaseous fuels may subsequently be used or allocated. The search for compression efficiency improvement before supply is not proposed by this solution.

Another public gas compressor in WO2014121251A2 provides a compressor suitable for compressing natural gas from a pressure associated with a residential gas supply to a pressure suitable for a car gas tank. The compressor uses a pair of pneumatic cylinders driven by a hydraulic cylinder to compress the gas in a multi-stage process. Regarding the gas compressor part and the drive part, several embodiments are provided. A pressure booster system using an internal control valve and an internal orifice through the piston of one of the pneumatic cylinders are also provided. This compressor does not have any selective dosing system.

In some countries, in order to being able to supply CNG, it is mandatory to provide a bunker or a protection in the compressor so that it becomes anti-explosive. U.S. Pat. No. 6,732,769B2 is a precedent thereof, where a compressed natural gas (CNG) modular station and a method to avoid fires at said station are proposed. A compressed natural gas modular station includes a modular compact unit with a flat support surface, sidewalls and a removable roof. Inside the modular compact unit at least two distinct zones are defined: a first anti-explosive zone where a set of gas storage vessels and a compressor unit are housed, and a second zone where a drive motor of said compressor unit is housed.

Another precedent of protection for compressors is the one disclosed in CN105736319A, whose sulfur-resistant compressor integrally mounted on a skid with explosion-proof electrical control cabinet.

The inventions highlighted above refer to solutions for remotely supplying gas to a refueling station, as well as to protect a gas compressor in order to make it anti-explosive. Nevertheless, none of the precedents proposes a variable dosing system based on the inlet pressure adapted for a compressor inside an anti-explosion enclosure.

### SUMMARY OF THE INVENTION

In order to solve the practical limitations and drawbacks of gas compressors in remote locations, the present invention refers to an anti-explosive compressor with selective dosing that has been developed, specifically designed to improve the energy efficiency of compression.

The equipments of variable gas inlet pressure work as a standard compressor or booster in the same product and they are the most effective solution to cover the needs in areas where there is no gas pipeline network yet. This versatility allows them to receive gas from gas transport units, or directly from the pipeline network, and supply a CNG refueling station under normal conditions, achieving the best performance and saving energy.

From a gas transport unit, the suction pressure fluctuates from 250 to 14 bar, and from a gas pipeline network, it varies from 9 to 60 bar.

The compressor installed inside the anti-explosion coverage receives gas from a trailer transporting the gas at a pressure of 250 bar and the supply to the user is 200 bar, so the decompression of this gas will not be necessary until it goes below 200 bar, with valves installed in the refueling station.

For this purpose, a census system has been incorporated to determine the inlet pressure to the compressor and a PLC (Programmable Logic Controller) system determines the need to perform 3 or 2 compression stages, depending on the pressure measured at the compressor inlet.

When the range of the trailer pressure is high, the compressor is automatically configured in two compression stages.

During unloading, the trailer pressure decreases and when it reaches a low-pressure range (around 50 bar), the compressor is configured in three compression stages.

Due to a local safety legal provision, gas compressors must operate within an anti-explosion enclosure, either by using a bunker or a coverage specifically designed for gas compressors that includes safety measures such as anti-explosive cabin, and a storage venting system.

Therefore, it is the object of the present invention to provide an anti-explosive natural gas compressor with selective dosing, depending on outlet pressure of the trailer.

### BRIEF DESCRIPTION OF THE DRAWINGS

To specify the advantages thus briefly commented, to which many others may be added by users and those skilled in the art, and in order to ease the understanding of constructive, constitutive and functional characteristics of the invented machine, a preferred embodiment example is described below, which is illustrated, schematically and without a given scale, in the attached illustrations. It is expressly remarked that, since it is an example, assigning it a limitative or exclusive character of the scope of protection of the present invention is not applicable, but simply assists a merely explanatory and illustrative intention of the basic conception on which the present invention is based.

FIG. 1 is a perspective view of the anti-explosive gas compressor, object of the present invention, according to a dimensional shape thereof.

Figure is a detailed view that shows how the gas is allocated when the supply pressure is high.

FIG. 3 is a detailed view that shows how the gas is allocated when the supply pressure is low.

### DETAILED DESCRIPTION OF THE INVENTION

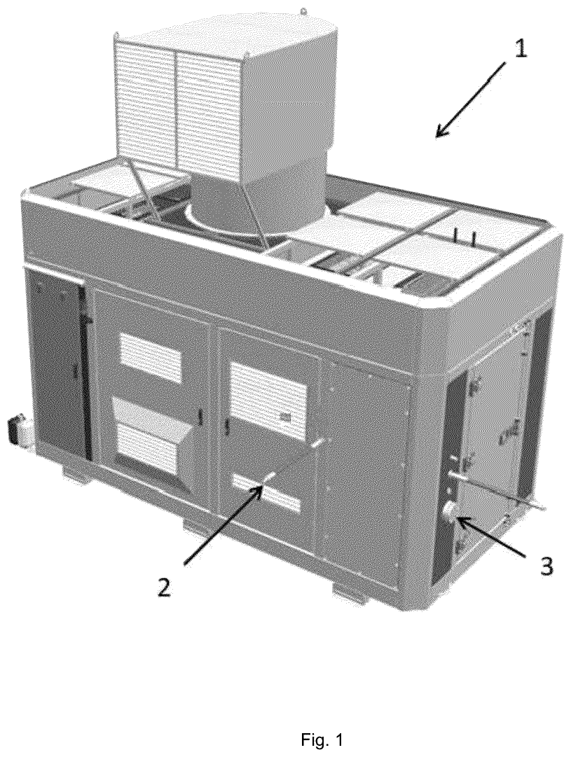

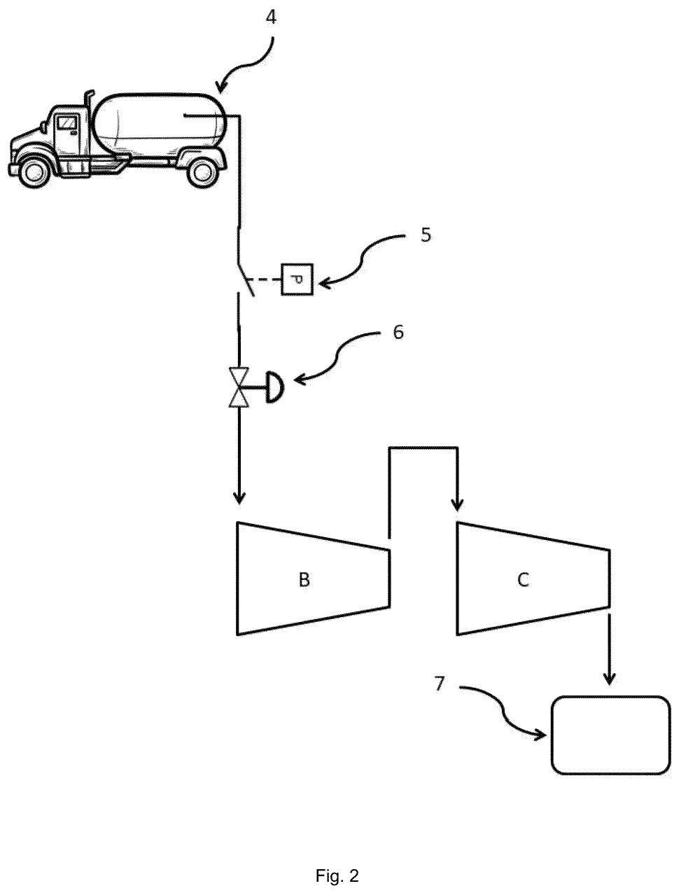

FIG. 1 shows a gas compressor configured inside an anti-explosive cabin (1), which was adapted to be supplied from a trailer or remote supply. For this purpose, a new gas inlet (2) was designed and the standard compressor inlet (3) was blocked.

FIG. 2 details the circuit that passes through the gas when the pressure range in the trailer (4) is high (approximately 250 to 50 bar), the compressor is automatically configured in two stages of compression by recourse to the signal received from the inlet pressure sensor (5) located after the inlet nozzle (2) and prior to passing through a regulating valve (6) that will normalize its pressure before entering the cylinder of the second stage of compression (B). The gas already compressed in this stage, will move on to the third stage of compression (C) and then it will go to a warehouse (7), before going to the unloading stations.

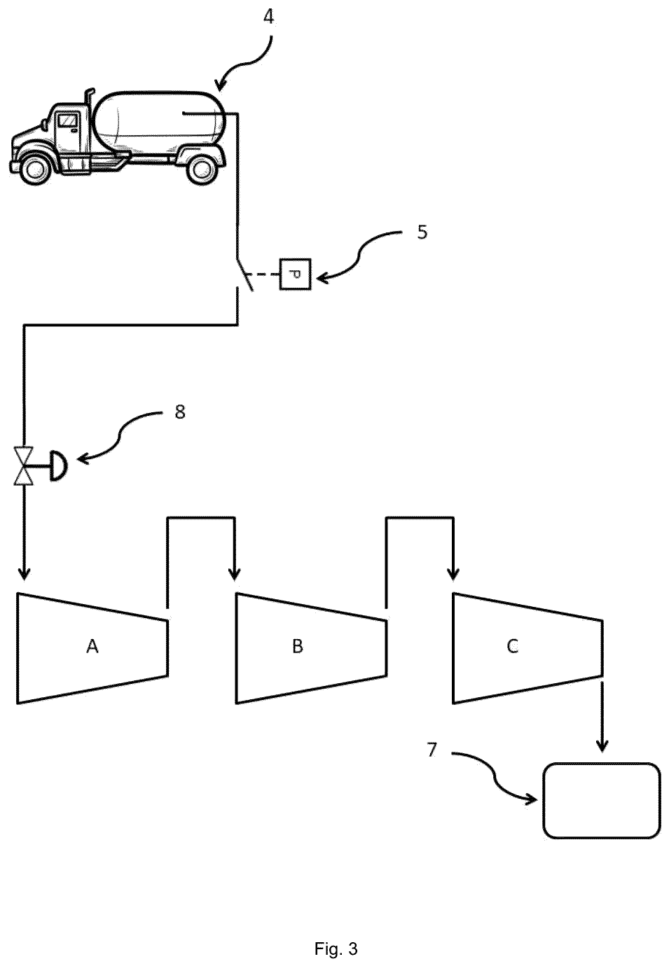

FIG. 3 exhibits the circuit that passes through the gas when the trailer has low gas pressure; the compressor is automatically configured to work in three stages. The gas, passing through the other regulating valve (8), goes to the cylinder of the first stage of compression (A). Subsequently, it will go through stage B and C of compression to be stored (7) prior to its supply.

Thus, having specially described and determined the nature of the present invention and the manner in which it will be put into practice, it is hereby declared to claim ownership and exclusive right:

1. Anti-explosive natural gas compressor with selective dosing specially designed to improve efficiency in compressors located in remote areas where a gas pipeline is out of reach; comprising:
an inlet pressure sensor located next to an inlet nozzle, said inlet nozzle being linked to a controller driven by a programmable logic controller (“PLC”) which automates the gas supply according to an inlet pressure indicated by said inlet pressure sensor and which determines the number of compression stages to be performed, said controller being associated with a regulating valve that normalizes its pressure before entering a lung dosing the gas towards the unloading cylinder,
wherein a supply pressure of the natural gas compressor decreases when the pressure in the trailer is reduced, and
wherein the natural gas compressor is located inside an anti-explosive cover to receive gas from a transport trailer that delivers the gas at a predetermined supply pressure which, through installed valves, produces decompression until it passes below 200 bar.

2. The Anti-explosive natural gas compressor with selective dosing according to claim 1, wherein the controller driven by a PLC, depending on the inlet pressure indicated by the pressure sensor, determines the number of compression stages to be performed, which are two stages for inlet pressures above 50 bar and three stages for pressures below 50 bar.

3. The Anti-explosive natural gas compressor with selective dosing according to claim 1, wherein the whole assembly of claim 1 is inside an anti-explosion enclosure consisting of vertical steel plates covering the entire perimeter of the compressor, specially designed to direct the explosion upwards, nozzles to ensure a correct venting and fire extinguishers in case of a fire.
